(19) United States
(12) Patent Application Publication
(10) Pub. No.: US 2014/0187685 A1
(43) Pub. Date: Jul. 3, 2014

(54) COMPOUND FOR CABLE JACKETS

(71) Applicant: NEXANS, Paris (FR)

(72) Inventors: Andreas Roos, Dusseldorf (DE); Armin Niehaus, Ge Venlo (NL)

(21) Appl. No.: 14/076,459

(22) Filed: Nov. 11, 2013

(30) Foreign Application Priority Data
Nov. 23, 2012 (EP) 12 306 458.6

(51) Int. Cl. C08L 11/00; C08K 13/02

(52) U.S. Cl. CPC C08L 11/00; C08K 13/02
USPC 524/108

(57) ABSTRACT

A crosslinkable polymer mixture is provided based on a chlorinated polymer, in particular based on sulfur-free polymer. It can be used for the production of cables and lines via extrusion and subsequent crosslinking, in particular via heat and/or irradiation. A process is provided for the production of cables and lines with such a polymer mixture, which following production via mixing of the ingredients is extruded and crosslinked. A feature of the polymer mixture is that, prior to the extrusion and crosslinking that follow production thereof via mixing, it is stable in storage.

### RELATED APPLICATION

This application claims the benefit of priority from European Patent Application Nb. 12 306 458.6, filed on Nov. 23, 2012, the entirety of which is incorporated by reference.

### BACKGROUND

1. Field of the Invention

The present invention relates to a crosslinkable polymer mixture based on a chlorinated polymer, in particular based on sulfur-free polychloroprene (“W”and/or “T” type), optionally in a mixture with at least one other crosslinkable polymer, for example natural rubber (NR) and/or styrene-butadiene rubber (SBR) for use for the production of cables and lines via extrusion followed by crosslinking, in particular via heat and/or irradiation. The invention. further relates to a process for the production of cables and lines with the claimed polymer mixture, which following production via mixing of the ingredients is extruded and crosslinked. A feature of the claimed polymer mixture here is that, prior to the extrusion and crosslinking that follow production thereof via mixing, it is stable in storage, in particular for at least 20 days, preferably for at least 28 days, in each case at room temperature (RT), where the polymer mixture has adequate mechanical strength values after extrusion and crosslinking thereof, also after intermediate storage. The invention. further relates to lines and cables comprising the claimed polymer mixture which are obtainable via mixing of constituents thereof, followed by extrusion with crosslinking, optionally with storage between the production of she polymer mixture and extrusion thereof.

2. Description of Related Art

The English-language abstract of JP 61016938 describes a mixture made of chloroprene rubber with content of a hydrazine compound and magnesium oxide with a peroxide as crosslinking agent.

N,N′-Ethylenethiourea is known as crosslinking agent.

### OBJECTS AND SUMMARY

It is an object of the invention to provide an alternative polymer mixture based on a chlorinated polymer which in particular is polychloroprene, optionally in a mixture with at least one other crosslinkable polymer (for example NR, SBR), with content of mineral, fillers, plasticizers, anti-aging agents, processing aids and a crosslinking system, where, after mixing of the constituents thereof, the mixture is stable in storage, in particular for at least 28 days, determined at RT, so that after the extrusion and crosslinking which follow the storage the mixture has in essence the mechanical properties that are achieved by the extruded and crosslinked polymer mixture after a relatively short storage time prior to extrusion, or in essence without any storage time prior to extrusion.

During work to prepare the invention it has been found that a polymer mixture which comprises a crosslinking system with content of N,N′-ethylenethiourea (ETU) has comparatively low stability in storage, this being discernible in that the storage of the mixture, following production thereof and prior to extrusion thereof with crosslinking that follows, causes the mechanical properties of the crosslinked mixture produced therefrom to decline as storage duration prior to extrusion and crosslinking increases. Increasing storage duration moreover leads, in layers extruded from the crosslinkable mixture, to an increased frequency of surface defects which can be produced by incipient crosslinking of the mixture.

The invention achieves the object by using the features of the claims and in particular by using the claimed polymer mixture and the process for the production of cables and lines with the said polymer mixture.

In the process for the production. of cables and lines, the crosslinkable polymer mixture must be produced via mixing of constituents thereof, and by way of example must be molded to give a strand. or pellets. The mixing can take place in a conventional mixing apparatus, for example a kneader and/or mixing extruder. After storage, for example in a storage container, the said crosslinkable polymer mixture is plasticified in an extruder and extruded. to give a layer of a cable or a line, for example in the form of intermediate layer or external, sheathing of a cable or a line. The extrusion of the crosslinkable mixture in the form of layer of a cable or a line is followed immediately by the crosslinking of the extruded. crosslinkable polymer mixture to give the crosslinked polymer mixture. The crosslinking preferably takes place via heating, for example to a temperature of at least 150° C., in particular to from 180° C. to 220° C., preferably at a pressure of from 12 to 22 bar, preferably at from 16 to 20 bar. Accordingly, the polymer mixture which has not vet been crosslinked. is a crosslinkable polymer mixture which, via the crosslinking, is converted to the crosslinked polymer mixture. After production of the crosslinkable polymer mixture via mixing of constituents thereof, it can optionally be stored, for example for at least 20 days, preferably for at least 28 days, e.g. at RT, prior to extrusion in the form of layer of a cable or a line with subsequent crosslinking.

The polymer mixture, which in particular is a sheathing mixture, comprises or is composed of polychloroprene, which in particular is sulfur-free, optionally with at least one other crosslinkable polymer (for example NR, SBR) , with fillers and added substances, and also with a crosslinking system.

The said fillers and added substances are in particular at least one mineral filler, in particular silica and/or calcined kaolin, in particular at from 20 to 100 phr, e.g. from 40 to 100 phr, in particular from 30 to 60 phr, of silica, preferably from 30 to 50 phr of silica, or from 40 to 50 phr of silica, and from 5 to 40 phr, in particular from 10 to 20 phr, of kaolin,

optionally colorant, preferably pigment colorant, in combination with titanium dioxide at from 2 to 10 phr, in particular at from 4 to 8 phr,

at least one plasticizer, for example at from 2 to 30 phr, in particular at from 5 to 15, for example dioctyl adipate, dioctyl sebacate and/or diphenyl cresyl phosphate,

anti-aging agent, in particular at from 2 to 10 phr, preferably at from 4 to 8 phr, for example 6 phr, by way of example selected. from octvlated diphenylamine (ODPA) and pentaerythritol bis (tetrahydrobenzaldehyde acetal),

processing aid, in particular, antiozonant wax or other wax, fatty acid derivatives and/or paraffin, for example at from 3 to 16 phr, preferably at from 4 to 14, in particular from 12 to 13 phr,

coupling agent, e.g. tris(2-hydroxyethyl)amine, in particular at from 0.5 to 4 phr,

a crosslinking system which comprises or is composed of methyl-2-mercaptobenzimddazole, in particular at from 0.3 to 2 phr, preferably from 0.5 to 1.0 phr, silane, especially trimethoxyvinvisilane, in particular at from 0.5 to 4 phr, preferably from 1.0 to 2.0 phr, 3-methyl-2-thiazolidinethione, in particular at from 0.5 to 4.0 phr, preferably at from 1 to 2.5 phr, or else 2-mercaptobenzothiazole disulfide, in particular at from 0.3 to 2 phr, preferably from 0.5 to 1.5 phr,

stabilizer, in particular MgO, for example at from 3 to 6 phr,

ZnO, in particular at from 3 to 6 phr, based on

100 phr of polychloroprene, optionally with content of at least one other crosslinkable polymer (for example from 0 to 40 phr of NR, SBR or a mixture of these). The parts stated in the mixtures are stated. in terms of phr (parts per hundred rubber), i.e. the proportions by weight of the constituents are based on one hundred parts by weight of organic polymer, selected from polychloroprene, optionally with content of at least. one other crosslinkable polymer (for example NP, SBR), for example with a proportion of from 10 to 40 phr, where the proportion of polychloroprene has been reduced by the of proportion of from 10 to 40 phr, Amounts in phr therefore correspond to % by weight based on the content of organic crosslinkable polymer.

The Mooney viscosity (ML1+4, 100° C.) of the polychloroprene is from 30 to 130, preferably from 40 to 80. The mixture is preferably free from ethylenethiourea.

It has been found that after production of the polymer mixture via mixing of constituents thereof it is stable in storage for a prolonged period during which the mechanical properties of the crosslinked polymer mixture produced therefrom via crosslinking exhibit adequate values than comparative mixtures, in essence identical, made of the same constituents with the exception of the crosslinking system, which comprises ethylenethdourea. By way of example, claimed crosslinkable polymer mixtures preferably have a Mooney scorch. time 15 at 121° C. of at least 800 s immediately after production of the mixture, i.e. without storage, and also after storage for 7 days at 40° C. or 28 days at RT, whereas a. comparative mixture which was identical except for the crosslinking system based on ethylenethiourea achieved only a value of about. 750 s without storage or after identical storage.

In comparison with comparative mixtures, in essence identical, made of the same constituents with the exception of the crosslinking system, which comprises N,N′-ethylenethiourea, claimed polymer mixtures moreover exhibit better processability and resulting surface quality, in particular after storage prior to extrusion and crosslinking thereof for a period which corresponds by way of example to storage for 7 days at 40° C. In comparison with comparative mixtures, in essence identical, made of the same constituents with the exception of the crosslinking system, which comprises N,N′-ethylenethiourea, the improved processability is apparent by way of example in that the claimed polymer mixtures have better flowability and allow a longer processing time before occurrence of undesired incipient crosslinking that causes subsequent. surface defects in an extruded layer.

Claimed polymer mixtures have the advantage that during storage of the crosslinkable polymer mixture the Mooney viscosity (ML1+4 at 100″C) alters to a lesser extent than that of comparative mixtures made of constituents that are in essence identical, but with a crosslinking system based on N,N′-ethylenethiourea. The crosslinkable polymer mixture can by way of example be stored for at least 20 days, preferably at least 28 days at 40° C. The Mooney viscosity of crosslinkable claimed polymer mixtures is moreover within. the range which covers the Mooney viscosity of crosslinkable comparative mixtures which have not been stored, composed of in essence identical constituents, but with a crosslinking system based on N,N′-ethylenethiourea.

A feature of cables and lines with a layer made of the crosslinked claimed polymer mixture is that the said layer comprises no free ethylenethiourea and no reaction products of N,N′-ethylenethiourea. The mechanical properties are within the range of the values that are achieved by comparative mixtures that are in essence identical, made of the same constituents, which with the exception of the crosslinking system, which comprises N,N′-ethylenethiourea. For the mixture described these are by way of example a tensile strength of from 14.8 to 15.8 N/mm² and an elongation at break of from 700 to 850% for the crosslinked polymer mixture which were produced from crosslinkable polymer mixture after storage for 7 days at 40° C., in relation to crosslinked polymer mixture which was produced from crosslinkable polymer mixture without intermediate storage.

### BRIEF DESCRIPTION OF THE DRAWINGS

The invention is now described in more detail by taking examples of mixtures with reference to the figures, where

FIG. 1 shows Mooney viscosity data without and after storage of crosslinkable polymer mixtures and

FIG. 2 shows Mooney scorch viscosity data.

### DETAILED DESCRIPTION

The following polymer mixtures were produced via mixing of constituents thereof in a laboratory kneader under conventional conditions:

TABLE 1
Polymer mixtures, proportions in phr based on polychloroprene

| | ETU mixture | Claimed | Claimed |
|---|---|---|---|
| Constituent | (comparison) | mixture MTT1 | mixture MTT2 |
| Polychloroprene | 100 | 100 | 100 |
| Min. filler: | 45 | 45 | 45 |
| silica | | | |
| Min. filler: | 10 | 10 | 10 |
| Calcined kaolin | | | |
| Colorant | 5.4 | 5.4 | 5.4 |
| (TiO₂, Microlen Yellow | | | |
| B3RS-MC) | | | |
| Plasticizer | 8 | 8 | 8 |
| Anti-aging agent | 6 | 6 | 6 |
| Processing aid | 12.5 | 12.5 | 12.5 |
| Antioxidant | 3 | 3 | 3 |
| 70% methyl-2- | 0.7 | 0.7 | 0.7 |
| mercaptobenzimidazole | | | |
| N,N′-ethylenethiourea | 1.2 | 0 | 0 |
| (80% by weight on | | | |
| polymer carrier) | | | |
| Trimethoxymethylsilane | 0 | 2.0 | 2.0 |
| 50% bis(3-triethoxy- | 1.0 | 0 | 0 |
| silylpropyl)tetra- | | | |
| sulfane on wax carrier | | | |
| 80% 3-methyl-2- | 0 | 2.0 | 2.5 |
| thiazolidinethione | | | |
| 80% 2-mercaptobenzo- | 1.2 | 1.2 | 1.2 |
| thiazole disulfide | | | |
| MgO stabilizer | 5 | 5 | 5 |
| ZnO catalyst | 5 | 5 | 5 |

Plasticizer used preferably comprises a mixture of dioctyl adipate and/or dioctyl sebacate and/or diphenyl cresyl phosphate.

Anti-aging agent used preferably comprises a mixture made of octviated diphenylamine (ODPA), of a bisphenol (such as 2,2′-methylenebis(4-methyl-6-tert-butylphenol) and of a cyclic acetal (for example pentaerythritol bis(tetrahydrobenzaidehyde acetal)).

The crosslinking system of the comparative ETU mixture was composed of 1.2 phr of 80% N, N′ ethylenethdourea, 0.7 phr of 70% methyl-2-mercaptobenzimidazole, 1.0 phr of 50% bis (3-triethoxysilylpropyl)tetrasulfane on wax carrier and 1.2 phr of 80% 2-mercaptobenzothiazole disulfide.

The viscosities of these crosslinkable polymer mixtures were those in Table 2 below:

TABLE 2
Viscosities of the crosslinkable polymer mixtures

| Viscosity | Test | | ETU | MTT1 | MTT2 |
|---|---|---|---|---|---|
| measurement | parameter | Unit | mixture | mixture | mixture |
| ML1 + 4 | 100° C. | MU | 42 | 37 | 36 |
| MST5 | 121° C. | m:s | 13:1 | 34:21 | 34:33 |
| Rheometer T2 | 180° C./12 min | m:s | 1:07 | 2:52 | 2:31 |
| Rheometer T90 | 180° C./12 min | m:s | 6:32 | 7:29 | 7:01 |
| Rheometer ML | 180° C./12 min | dNm | 0.98 | 0.98 | 0.88 |
| Rheometer MH | 180° C./12 min | dNm | 13.34 | 10.27 | 10.27 |

The ML 1+4 viscosity measurement is generally made with large rotor (38.1 mm diameter) at 100° C., and the preheat interval, and the measurement interval have been given here in minutes (1 min and 4 min),

and the Mooney scorch time (MST5) is measured at 121° C.

The MDR measurement for the values T2 (time for rise to 2% of the plateau value in the MDR), T90 (time for rise to 90% of the plateau value in the MDR), ML (lowest value from the MDR measurement) and MH (highest value from the MDR measurement) takes place at 180° C.

The ML1+4 measurement results show that flowability is better for the claimed MTT1 and MTT2 mixtures than for the comparative ETU mixture.

The longer times for the MST5 measurement and for the 12 rheometer measurement show that the claimed mixtures permit greater flexibility of timing for extrusion before occurrence of undesired incipient crosslinking phenomena which. by way of example lead to surface defects in an extruded sheathing layer made of the mixture.

These measured values show that, by virtue of the crosslinking system composed of trimethoxysilane, methyl-2-mercaptobenzimidazole, 2-mercaptobenzothiazole disulfide and 3-methyl-2-thiazoliddnethione, but without N,N′-ethylenethiourea, the claimed mixtures have better processability than the comparative mixture which comprised a crosslinking system with N, N′-ethylenethiourea content.

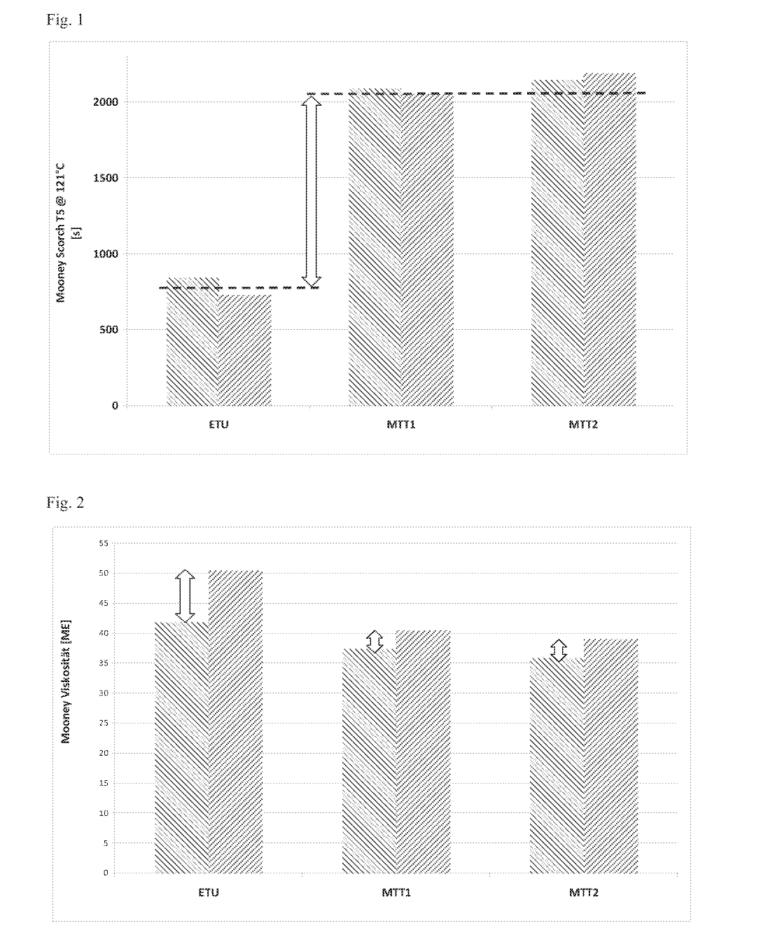

The viscosities of the crosslinkable polymer mixtures were determined at 100° C. in the Mooney viscometer, firstly without aging, for example about 2-10 h after mixing of the constituents, and secondly after artificial aging of the crosslinkable polymer mixtures via storage at 40° C. for 7 days as an example for storage of the crosslinkable polymer mixture prior to extrusion and crosslinking. FIG. 1 depicts the results, and each left-hand column here shows the viscosity of the respective polymer mixture without aging, while each right-hand column shows the viscosity after artificial aging. From the values it is clear that the claimed MTT1 and MTT2 polymer mixtures suffer markedly less change of Mooney viscosity due to the aging than the comparative ETU mixture. This shows that the crosslinkable polymer mixture of the invention has higher stability in storage.

FIG. 2 shows the results from the determination. of Mooney scorch time (Mooney scorch) at 121° C., firstly without aging (in each case left-hand column), for example about 2-10 h after mixing of the constituents, and secondly after artificial aging of the crosslinkable polymer mixtures via storage at 40° C. for 7 days (in each case right-hand column) as example for storage or the crosslinkable polymer mixture prior to extrusion and crosslinking. The results show that the crosslinking system of the claimed. MTT1 and MTT2 polymer mixtures increases the scorch time or incipient-crosslinking time and thus has an advantageous effect on processability.

FIG. 2 moreover shows that the effect on the scorch time of the claimed crosslinkable polymer mixture due to the artificial aging, which represents storage, is less strong than the effect on the scorch time of the comparative ETU mixture due to storage.

The mechanical properties of the polymer mixture after crosslinking are shown in Table 3 and from these it is clear that the crosslinked claimed polymer mixtures achieve sufficient mechanical strength values. The abovementioned crosslinkable polymer mixtures were crosslinked to give test sheets via heating to 180° C. under pressure, which was applied via a hydraulic ram.

TABLE 4
Mechanical strength values of crosslinked polymer mixtures

| Hardness | ETU | MTT1 | MTT2 |
|---|---|---|---|
| Tensile strength [N/mm²] | 17.3 | 16.3 | 16.1 |
| Elongation at break [%] | 710 | 791 | 803 |

The values in Table 4 were determined in accordance with EN60811-1-1/9.1. These values show that, after crosslinking, the claimed polymer mixtures exhibit a tensile strength and elongation at break that are comparable with the original, ETU-containing mixture and that are sufficient in particular for the use as cable sheathing.

1. Crosslinkable polymer mixture for use as sheathing mixture for electrical and/or optical cables and lines which has polychloroprene content comprising:
as polymer, 100 phr of polychloroprene which. comprises from 0 to 40 phr content of natural rubber (NR) and/or styrene-butadiene rubber (SBR),
from 20 to 100 phr of mineral filler,
optionally colorant,
at least one plasticizer,
anti-aging agent,
from 3 to 16 phr of processing aid,
optionally from 0.5 to 4.0 phr of coupling agent,
a crosslinking system which comprises from 0.3 to 2.0 phr of methyl-2-mercaptobenzimidazole, from 0.5 to 4.0 phr of silane, from 0.5 to 4.0 phr of 3-methyl-2-thiazolidinethione and from 0.3 to 2 phr of 2-mercaptobenzothiazole disulfide,
from 3 to 6 phr of stabilizer,
from 3 to 6 phr of ZnO as catalyst.

2. Polymer mixture according to claim 1, wherein no N,N′-ethylenethiourea is present.

3. Polymer mixture according to claim 1, wherein the polymer is composed of 100 phr of sulfur-free polychloroprene.

4. Polymer mixture according to claim 1, characterized in that the mineral filler comprises from 40 to 100 phr of silica.

5. Polymer mixture according to claim 1, wherein the mineral filler comprises from 5 to 40 phr of kaolin.

6. Polymer mixture according to claim 1, wherein from 2 to 30 phr of the plasticizer is present.

7. Polymer mixture according to claim 1, wherein from 2 to 10 phr of anti-aging agent is present.

8. Polymer mixture according to claim 1, wherein, after artificial aging at 40° C. for 7 days, its Mooney scorch time MST5 is at least 13 min, measured at 121° C., and its Mooney viscosity increase after storage is at most 6 MU, ML1+4 measured at 100° C.

9. Polymer mixture according to claim 1, wherein, after crosslinking, its tensile strength is at least 14 N/mm² and its elongation at break is at least 500%.

10. Cable or line with sheathing made of a polymer mixture according to claim 9.

11. Process for the production of cables or lines with extrusion of a crosslinkable polymer mixture and with subsequent crosslinking, wherein the crosslinkable polymer mixture is one according to claim 1.

12. Process according to claim 11, wherein the crosslinkable polymer mixture is produced via mixing of
100 phr of polychloroprene and/or NP and or SBR,
from 40 to 1000 phr of mineral filler,
optionally colorant,
at least one plasticizer,
anti-aging agent,
from 3 to 16 phr of processing aid,
optionally from 0.5 to 4.0 phr of coupling agent, 2.0 phr of methyl-2-mercaptobenzimidazole, from 0.5 to 4.0 phr of trimethoxyvinyisilane, from 0.5 to 4.0 phr of 3-methyl-2-thiazolidinethione and from 0.3 to 2 phr of 2-mercaptobenzothiazole disulfide,
from 3 to 6 phr of stabilizer,
from 3 to 6 phr of ZnO as catalyst.

13. Process according to claim 11, wherein, prior to extrusion and crosslinking, the crosslinkable polymer mixture is stored under conditions which correspond to at least 5 days of artificial aging at 40° C.

14. Process according to claim 11, wherein the crosslinking takes place at at least 150° C.
